(19) United States
(12) Patent Application Publication
(10) Pub. No.: US 2010/0034170 A1
(43) Pub. Date: Feb. 11, 2010

(54) Network Node and Mobile Terminal

(75) Inventors: Jun Hirano, Kanagawa (JP); Chun Keong Benjamin Lim, Singapore (SG); Chan Wah Ng, Signapore (SG); Tien Ming Koh, Signapore (SG); Pek Yew Tan, Singapore (SG)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, OSAKA (JP)

(21) Appl. No.: 12/527,548

(22) PCT Filed: Feb. 22, 2008
(86) PCT No.: PCT/JP2008/000310

§ 371 Date: Aug. 17, 2009

(30) Foreign Application Priority Data
Feb. 23, 2007 (JP) 2007-044718

(51) Int. Cl. H04W 36/00

(52) U.S. Cl. 370/331

(57) ABSTRACT

Disclosed in a technique for more accurately checking a network condition such as a transmission delay generated in packet transmission between two nodes and other network conditions. A buffering node 10 is a network node having the function of transferring a packet. When a packet received by a network interface 11 is buffered in a cache 14, a buffer time processor 12 refers to an internal clock 13 to record the time of that moment (the buffered time). Then, when this packet is transferred, the buffer time processor refers again to the current time indicated by the internal clock and subtracts the buffered time from the current time to calculate a buffering time generated by a buffering delay in packet transmission. This buffering time is added to the packet and transmitted.

### TECHNICAL FIELD

The present invention relates to the field of communication technology for packet-switched data communication network systems. In particular, the present invention relates to a network node and a mobile terminal for determining a packet transmission delay due to buffering and other network conditions in a packet-switched data communication network system.

### BACKGROUND ART

In communication network systems, including the current Internet infrastructure, a path from a source to a destination may be different from a reverse path from the destination to the source.

For example, when the arrangement of respective routers, which form a transfer path between the source and the destination, is different from the arrangement of routers, which form a reverse path, the two paths differ. In such a state, if a measurement is made for one round-trip, performances of two different paths are actually measured together.

However, since the outbound and inbound paths between the source and the destination are asymmetric, if the path in each direction is measured, respectively, performance may greatly differ between the paths in the two different directions. For example, if the paths go through different ISPs (Internet Service Providers) or different types of networks (e.g., research network and commercial network, or ATM network and Packet Over SONET), the difference between the performances of the two paths becomes pronounced.

On the other hand, network application performance is often dependent on the performance of a one-way path. For example, file transfer using TCP (Transmission Control Protocol) tends to depend on performance in the direction of a data flow rather than in a direction in which an acknowledgement is transmitted.

This is also true especially in Monami6 (Mobile Nodes and Multiple Interfaces in IPv6). In Monami6, a mobile node (MN) can transmit a flow of data to a home agent (HA) through two or more paths. In Monami6, it is important for the MN to have a method of transmitting data from the HA to various interfaces. Therefore, the MN needs to test network conditions (packet transmission rate, latency, jitter, error rate, packet loss rate, etc.) for the various interfaces to determine which path is best suited to a specific flow.

For example, NTP (Network Time Protocol) described in Non-Patent Document 1 cited below and ICMP (Internet Control Message Protocol) described in Non-Patent Document 2 cited below can be combined to test network conditions for paths between the MN and the HA.

NTP is a protocol for clock synchronization between computer systems in a packet-switched, variable-latency data network. NTP is designed particularly not to be affected by variable latency.

In the case of use of NTP, the MN can use an ICMP echo request message to cause the HA to return an ICMP echo response message with a timestamp. Then, the MN can figure out a delay between the MN and the HA based on a difference between time for the MN to receive the ICMP echo response packet and the timestamp attached to the ICMP echo response packet (i.e., time at which the ICMP echo response message was processed at the HA).

Particularly in the case of mobile communication, the MN is movable and likely to connect to different access points with time. For example, suppose that a specific person starts using a laptop having a wireless interface and a cellular interface in a train during a trip. Several APs (Access Points) are located along the train route, and the APs provide a continuous wireless coverage.

Therefore, the wireless interface of the laptop performs handoff beforehand using a technique such as fast mobile IP (FMIP) so that the session can continue.

After handoff to a new AP, the laptop can have a home agent test new network conditions related to the interface that has changed the connection to determine whether requirements of a specific data flow are still satisfied on the new access link. Such a trigger is performed using, for example, the ICMP echo request message transmitted from the laptop to the HA.

Patent Document 1 cited below discloses a technique for determining network characteristics, such as bandwidth, transmission delay, queuing delay, and packet size in a network between two nodes, using successive test packets of various sizes.

In the case of a one-way test, a receiving node collects test packet results and generates a report. Further, using this statistical report on the one-way test, the receiving node can determine a difference between an average delay and the minimum delay of round-trip times of packets of various sizes to calculate an average queuing delay (buffering delay).

Further, in a technique described in Patent Document 2 cited below, a responder needs to add a delta time to a field in a probe packet in addition to the transmission/reception time. This delta time is a value indicating how long the recipient holds a packet. Use of the delta time in addition to the transmission/reception time enables more accurate calculation of the transmission delay time between the sender and the recipient.

Patent Document 1: U.S. Pat. No. 5,477,531

Patent Document 2: U.S. Pat. No. 6,868,094

Non-Patent Document 1: Mills, D., “Network Time Protocol (Version 3) Specification, Implementation and analysis,” RFC 1305, March 1992.

Non-Patent Document 2: Postel, J., “Internet Control Message Protocol,” RFC 792, September 1981.

However, suppose as mentioned above that FMIP is used in an environment where NTP and ICMP is used in combination to figure out a delay between the MN and the HA. The train may enter an area, where radio communication is disabled, between two radio communication points, such as a tunnel, for example. Before the train enters the tunnel, the laptop computer uses FMIP to connect to a new AP, and notifies the HA that it is about to perform handover to the new AP. The HA is activated (triggered) to test a new access link of the laptop and transmit test packets to the new AP.

At this time, the laptop is located in the tunnel (i.e., in the area where wireless communication is disabled), and cannot connect to the new AP. Therefore, the test packets are buffered at the new AP until the laptop computer establishes a connection to the new AP. This buffering causes a delay for the laptop computer to receive the test packets, resulting in a problem that the measurements of access link conditions (network conditions) using the test packets will be inaccurate.

Further, if many MNs located in the train are managed by the same HA, the HA will receive many ICMP echo request messages almost at the same time from the many MNs in the train, significantly increasing the instantaneous load on a processor of the HA because of the need to process the many ICMP echo requests messages.

However, according to the technique described in Patent Document 1, when a number of test packets large enough for each size are sent out, there is a need to assume that at least one of these packets passes through the network without being subjected to queuing. This packet will record the minimum round-trip time. Thus, a large number (sufficient number) of test packets should be sent out, and furthermore inaccurate results may be obtained since the minimum round-trip time of a packet is just based on assumption.

However, according to the technique described in Patent Document 2, it is not efficient for a recipient to receive lots of probe packets, and is less desirable for the network. Testing of such access conditions may be started in such a manner that the recipient receives a data packet transmitted to a sender. In this case, there is no need to transmit the probe packets.

### DISCLOSURE OF THE INVENTION

In order to solve the above problems, it is an object of the present invention to provide a network node and a mobile terminal capable of more accurately calculating a transmission delay caused in packet transmission between two nodes in a packet-switched data communication network and checking packet transmission conditions (network conditions).

In order to attain the above object, the network node of the present invention is a network node connectable to a network, comprising:

packet receiving means for receiving a packet from the network;

packet buffer means for buffering the packet;

start of transfer determining means for determining start of transfer of the packet buffered in the packet buffer means;

packet transmitting means for transmitting, to a specific address, the packet buffered in the packet buffer means and for which the start of transfer is determined;

buffering time calculating means for calculating buffering time for which the packet was buffered in the packet buffer means; and

buffering time information transmitting means for transmitting, as buffering time information, the buffering time calculated by the buffering time calculating means to a forwarding destination of the packet to be transmitted by the packet transmitting means.

In addition to the above structure, the network node of the present invention may also comprise:

clock means having a clock function; and

buffer time processing section for storing, as buffer time information, time of a moment obtained from the clock means in association with the packet destined for the specific address, and causing the packet buffer means to buffer the packet destined for the specific address,

wherein when the start of transfer of the packet is determined by the start of transfer determining means, the buffering time calculating means calculates, based on current time obtained from the clock means and the buffer time information, buffering time information indicative of the buffering time for which the packet was buffered.

Further, in addition to the above structure, the network node of the present invention may comprise:

buffer request receiving means for receiving a buffer request for the packet destined for a mobile terminal when the forwarding destination of the packet is the mobile terminal, the packet being transmitted within the network while the mobile terminal is performing handover processing; and

buffer control means for buffering, in the packet buffer means, the packet destined for the mobile terminal while the mobile terminal is performing the handover processing,

wherein when detecting completion of the handover of the mobile terminal, the start of transfer determining means determines the start of transfer of the packet to the mobile terminal.

Further, in addition to the above structure, the network node of the present invention may be such that, when a request for the buffering time is received from a terminal as the forwarding destination of the packet, the buffering time related to the packet destined to the terminal that made the request is provided to the terminal.

Further, in addition to the above structure, the network node of the present invention may be such that the buffering time information transmitting means transmits the buffering time information in such a manner to add the buffering time information to an end of a layer 2 frame of the packet or a tunnel header added to the packet.

In order to attain the above object, the network node of the present invention is a network node connectable to a network, comprising:

packet transfer means for transferring a packet transmitted in the network;

filter rule storing means for storing a filter rule related to a specific terminal; and

test starting means for performing processing to check a network condition up to the specific terminal associated with the filter rule that matches a condition when the packet transfer means receives the packet that matches the condition of the filter rule stored in the filter rule storing means.

In addition to the above structure, the network node of the present invention may also comprise:

duplicate packet creating means for duplicating the packet received by the packet transfer means to create a duplicate packet when the packet transfer means transfers the packet to the specific terminal; and

duplicate packet transmitting means for transmitting the duplicate packet to the specific terminal via a path different from a path through which the packet transferred by the packet transfer means passes.

Further, in addition to the above structure, the network node of the present invention may comprise:

clock means having a clock function; and

timestamp means for adding, to the packet and the duplicate packet, current time obtained from the clock means when being sent to the network.

Further, in addition to the above structure, the network node of the present invention may be such that the test means transmits a test packet periodically to check a network condition up to the specific terminal.

Further, in addition to the above structure, the network node of the present invention may be such that the test means transmits test packets of plural sizes to plural paths to the specific terminal, respectively.

Further, in addition to the above structure, the network node of the present invention may comprise

packet buffer means for buffering the packet transferred by the packet transfer means,

wherein the test means performs processing to check a network condition up to the specific terminal by transfer of the packet buffered in the packet buffer means.

In order to attain the above object, the mobile terminal of the present invention is a mobile terminal communicable with a network while moving, comprising:

packet sending/receiving means for connecting to the network to send and receive a packet;

buffering request means for requesting the network to buffer the packet destined for the mobile terminal in the network;

buffering time record requesting means for requesting the network to record buffering time for which the packet was buffered due to buffering requested by the buffering request means; and

buffering time receiving means for receiving the buffering time of the packet from the network in conjunction with reception of the packet buffered in the network.

In addition to the above structure, the mobile terminal of the present invention may also comprise:

packet sending time acquiring means for acquiring packet sending time when the packet was sent, from an arbitrary packet transfer device that transferred the packet buffered in the network;

packet receiving time acquiring means for acquiring packet receiving time when the packet buffered in the network was received by the packet sending/receiving means; and

effective latency calculating means for calculating a value as effective latency required for packet transmission from the arbitrary packet transfer device to the mobile terminal, the value obtained as a result of subtraction of the packet sending time from the packet receiving time and further subtraction of the buffering time of the packet.

Further, in addition to the above structure, the mobile terminal of the present invention may also comprise synchronization control means for synchronizing a clock referred to by the arbitrary packet transfer device to acquire the packet sending time with a clock referred to by the mobile terminal to acquire the packet receiving time.

Further, in addition to the above structure, the mobile terminal of the present invention may comprise:

plural interfaces connectable to the network; and

access condition acquiring means for acquiring an access condition to each link between each of the plural interfaces and the arbitrary packet transfer device based on the effective latency of each of the plural interfaces calculated by the effective latency calculating means.

The network node and the mobile terminal of the present invention have the above structures to enable more accurate calculation of a transmission delay generated in packet transmission between two nodes and checking of packet transmission conditions (network conditions).

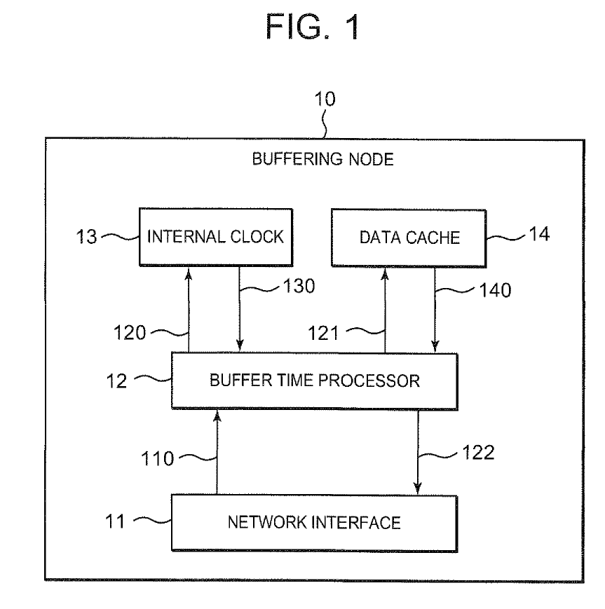

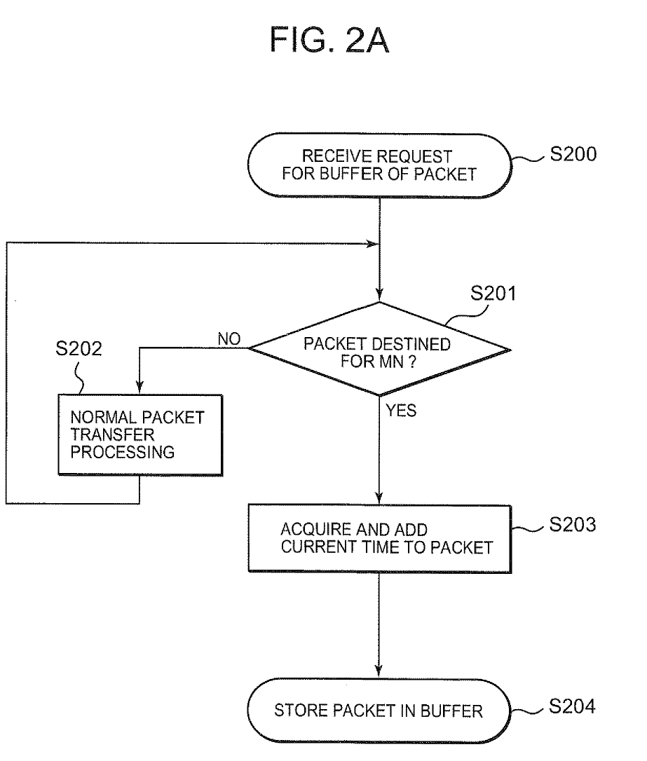

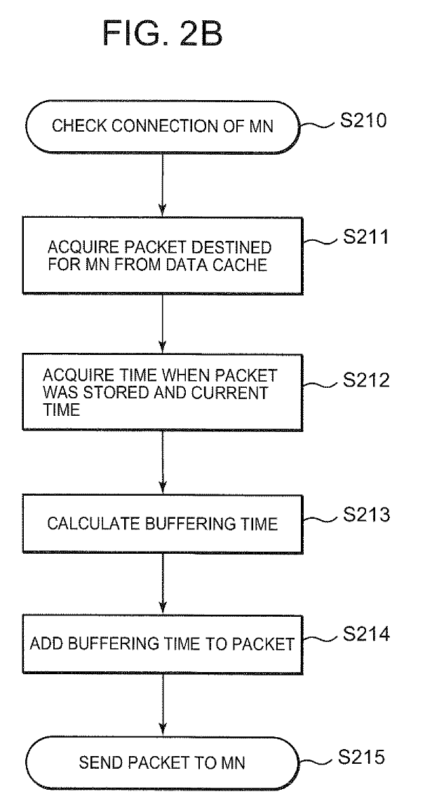

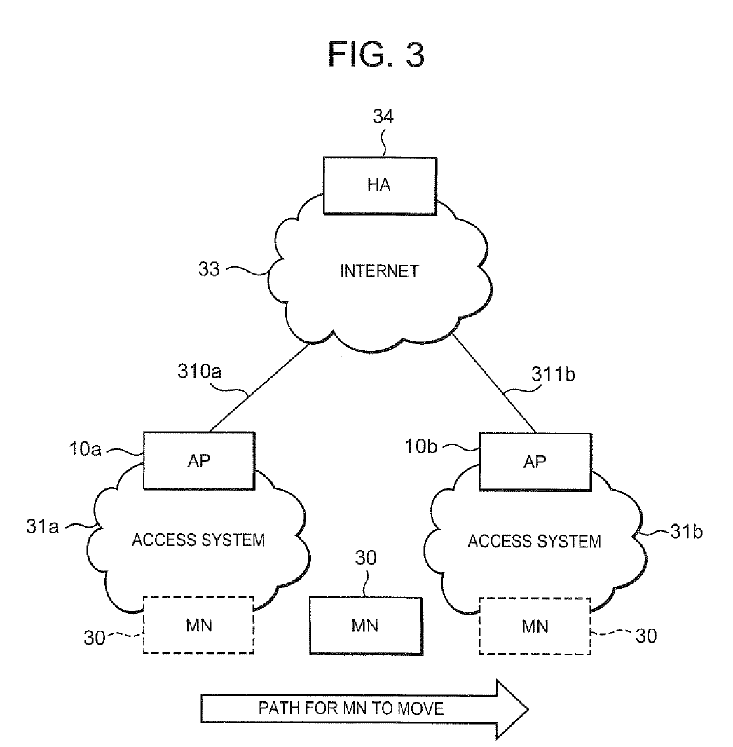

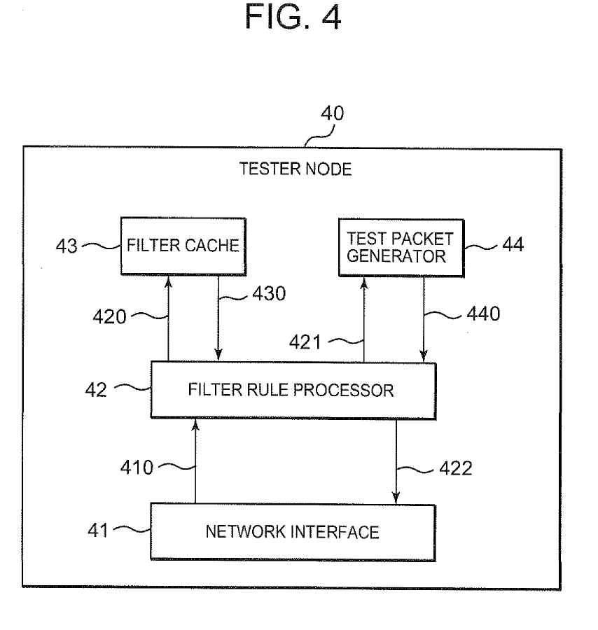

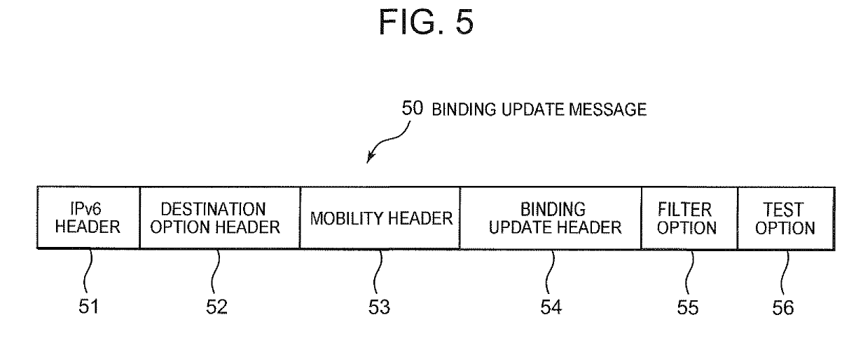

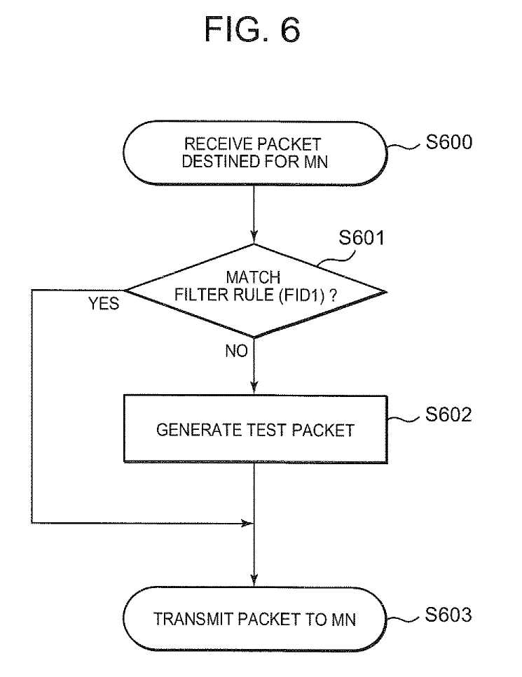

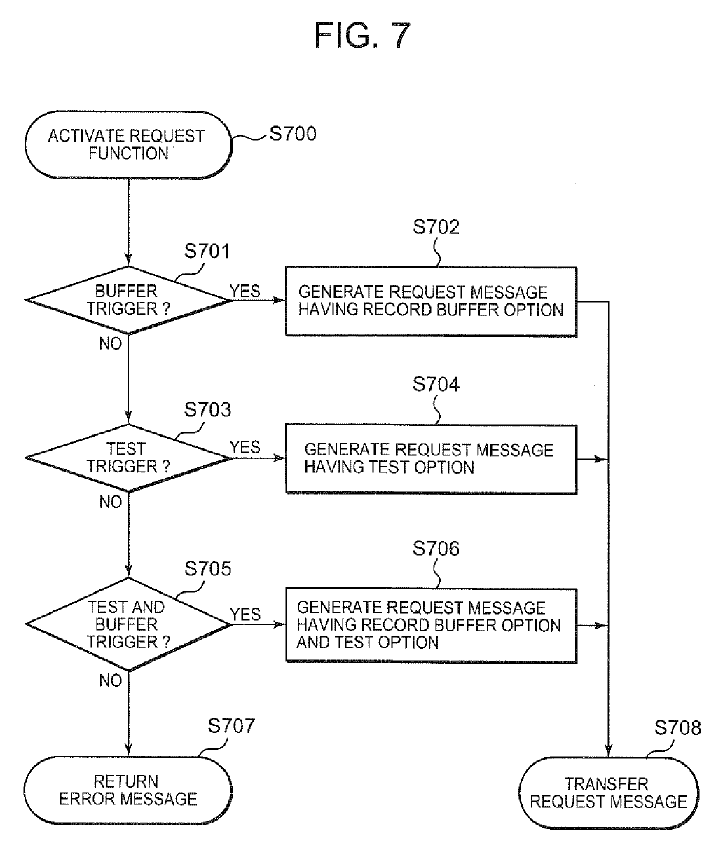

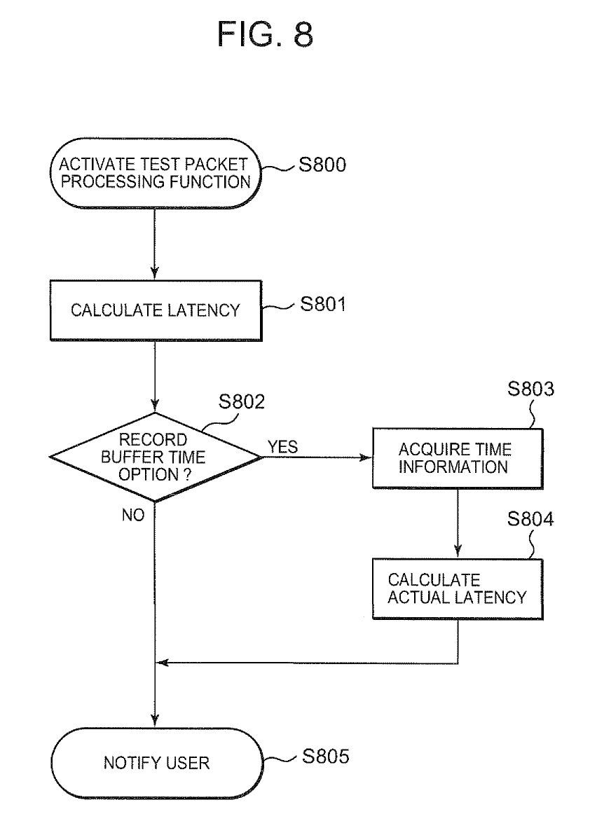

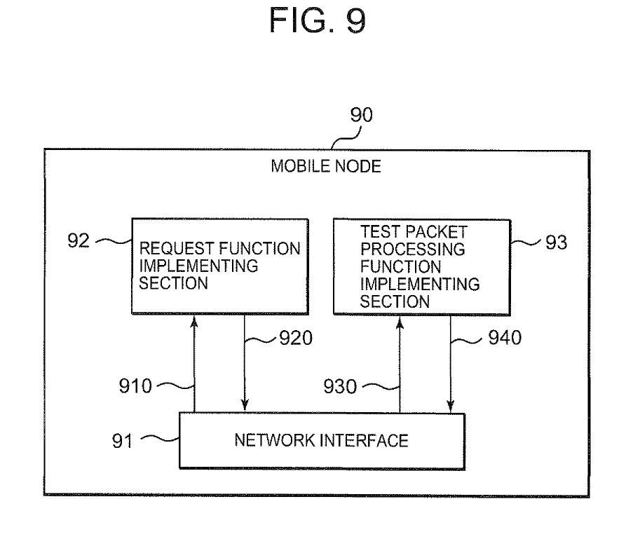

### BRIEF DESCRIPTION OF THE DRAWINGS

[FIG. 1] It is a diagram showing an example of a configuration of a buffering node in an embodiment of the present invention.

[FIG. 2A] It is a flowchart showing an example of packet buffering processing performed by a buffer time processor of the buffering node in the embodiment of the present invention.

[FIG. 2B] It is a flowchart showing an example of packet transfer processing performed by the buffer time processor of the buffering node in the embodiment of the present invention.

[FIG. 3] It is a diagram showing an example of a network configuration in the embodiment of the present invention.

[FIG. 4] It is a diagram showing an example of a configuration of a tester node in the embodiment of the present invention.

[FIG. 5] It is a diagram showing an example of a format of a binding update message used in the embodiment of the present invention

[FIG. 6] It is a flowchart showing an example of processing for the tester node in the embodiment of the present invention to determine whether a specific packet is a trigger for a test mechanism.

[FIG. 7] It is a flowchart showing an example of processing performed by an MN in connection to various requests to be processed by the mobile node in the embodiment of the present invention.

[FIG. 8] It is a flowchart showing an example of processing performed when the mobile node in the embodiment of the present invention receives a test packet.

[FIG. 9] It is a diagram showing an example of a configuration of the mobile node in the embodiment of the present invention.

### BEST MODE FOR CARRYING OUT THE INVENTION

An embodiment of the present invention will be described below with reference to the drawings. In the following description, although a specific number, time, configuration, protocol name, and other parameters may be described in detail to describe the present invention, such specific conditions used in this specification are just used to describe the present invention and do not limit the present invention. Further, known components or modules are illustrated, for example, in block diagrams to avoid making it unnecessarily too difficult to understand the present invention.

The present invention is configured such that a buffering node itself indicates how long a packet was buffered in a cache of the buffering node (buffering time), for example. This allows a node to use this information (information about the buffering time of the packet) to more accurately calculate the latency of the packet transmitted via the buffering node.

In this specification, the term “buffering node” represents a communication network node that buffers a packet for a node requesting a buffering service (buffering of the packet at the packet buffering node).

Further, when the requesting node further requests the buffering node to indicate the time when the packet was buffered (buffering time), the buffering node notifies the requesting node of information about the buffering time of the packet.

In this specification, a case where an access point (AP) primarily serves as the buffering node will be described, but any communication device having a data storage function can also serve as the buffering node.

Further, in this specification, the term “requesting node” represents a communication network node requesting the buffering node to buffer a packet destined for the requesting node. As mentioned above, the requesting node can also request the buffering node to provide information about buffering time during which the packet was buffered at the buffering node.

In addition, a case where a mobile node (MN) primarily serves as the requesting node will be described in this specification, but the requesting node may be either the mobile node or a fixed node.

Further, in this specification, the term “timing information” represents the time required to buffer the packet at the buffering node (i.e., buffering time). The time information is added to the data packet before the data packet is transferred to the requesting node, for example.

FIG. 1 shows an example of the structure of a buffering node 10 in an embodiment of the present invention. The buffering node 10 shown in FIG. 1 has one or plural network interfaces 11, a buffer time processor 12, an internal clock 13, and a data cache 14.

The network interfaces 11 forms a functional block containing all hardware and software necessary for the buffering node 10 to communicate with another node through any communication medium.

In terms of terminology, known to those skilled in the art, the network interfaces 11 represent communication components, firmware, drivers, and communication protocols of layer 1 (physical layer) and layer 2 (data link layer). Although only one network interface 11 is shown in FIG. 1, the buffering node 10 can have one or plural network interfaces 11. The network interface 11 can also pass a packet to a buffer time processor 12 through a signal/data path 110.

The internal clock 13 has a clock function capable of generating a clock signal (e.g., a signal indicating the current time) used for the buffer time processor 12 to calculate the buffering time of a specific packet. The clock signal generated by the internal clock 13 is passed to the buffer time processor 12 through a signal/data path 130.

The data cache 14 has the function of caching a data packet to be buffered when buffering the data packets related to a specific requesting node that has requested a buffering service at the buffering node 10.

It is preferred that information reflecting the time when the packet was stored in the data cache 14 be added to the data packet in any format. The data packet with the time information added is sent to the buffer time processor 12 through a signal/data path 140 and processed.

Further, in the present invention, the buffering node 10 has the buffer time processor 12. This buffer time processor 12 has the function of calculating the buffering time of a data packet buffered in the data cache 14 of the buffering node 10.

For example, the buffer time processor 12 can determine a difference between the current time and the time when the data packet was stored in the data cache 14, and from this difference in time, figure out the time (buffering time) for which the data packet stayed in the data cache 14.

The buffer time processor 12 can also refer to the current time indicated by the internal clock 13 through a signal/data path 120. Further, the buffer time processor 12 can store, in the data cache 14, the data packet to which the current time acquired from the internal clock 13 through a signal/data path 121 is added.

Further, the buffer time processor 12 can transmit the time information to the network interface 11 through a signal/data path 122. At this time, the buffer time processor 12 sends the time information sequentially to requesting nodes (requesting nodes which are trying to get information related to buffering (buffering time, etc.)).

In the present invention, the requesting node can also request the buffering node 10 to assist in testing network conditions at the buffering node 10. For example, when the buffering node 10 supports a communication flow that is continuing with a correspondent node (CN), a mobile node as the requesting node needs to get the network conditions at the buffering node 10.

It is assumed here that the buffering node 10 is an AP (access point) that performs traffic flow processing on an MN after the MN performs handoff. The MN can identify the position of the AP using an information service provider specified by IEEE (Institute of Electrical and Electronics Engineers, Inc.) 802.21, for example, but it is not limited to this method.

Before the handoff processing, the MN not only requests buffering of a packet, but also transmits a message called a record buffering time message to the AP to instruct the AP to record buffering time of the packet sent to the MN. Note that the packet buffering request and the request to record the buffering time may be made by separate messages or may be combined into one message. The following describes a case where the requests are combined into one message.

The record buffering time message shall include, but not be limited to, MN identification information and information for requesting the AP to record the buffering time of the packet destined for the MN.

After the AP approves the request from the MN, the AP not only temporarily buffers received packets to be sent to the MN, but also adds, to each packet, the time when the AP received this packet. Then, after the MN completes the handoff processing, the AP transfers the buffered packets to the MN together with the time information (buffering information).

In this case, however, a malicious MN may request the AP to continuously buffer packets destined for the MN using the record buffering time message without intention of using them later. This may cause a DoS (Denial of Service) attack on the AP, and hence another node necessary for the buffering service at the AP not to be able to receive the service due to an overload on the buffer at the AP.

In order to minimize such an attack, the MN and the AP can negotiate with each other about the amount of buffered packets in a stage of transmission/reception of the record buffering time message.

In such a negotiation stage, for example, the MN can also notify the AP to buffer packets from a specific source address. Further, for example, when the AP assigns, to the MN, a length of time for buffering of packets but the MN does not acquire buffered packets prior to the expiration of the length of time, the AP can delete the buffered packets from the cache.

Further, among data to be buffered, buffering time can be measured for and added to only a packet used for measurement of latency to figure out a delay. This is determined by checking a specific field of a specific test message or by receiving a predetermined message to which the result of buffering time measurement is to be written (e.g., a message with a field prepared for writing the result of buffering time measurement).

FIG. 2A and FIG. 2B show a preferred method of the present invention, which uses the function of the buffer time processor 12 of the buffering node 10 to calculate how long a packet was stored in a cache of the buffering node 10. FIG. 2A is a flowchart showing an example of packet buffering processing performed by the buffer time processor of the buffering node in the embodiment of the present invention. FIG. 2B is a flowchart showing an example of packet transfer processing performed by the buffer time processor of the buffering node in the embodiment of the present invention.

In FIG. 2A, when receiving a buffer request for packets (record buffering time message) from an MN (requesting node), (step S200), the buffer time processor 12 performs check processing on all received packets to check whether a packet is destined for the MN (step S201).

If the received packet is not destined for the MN, the buffer time processor 12 performs normal processing (normal packet transfer processing) on the packet, and continues the check processing on the next packet received (step S202).

On the other hand, if the packet is determined to be destined for the MN, the buffer time processor 12 acquires the current time from the internal clock 13, and adds the value of this current time to the packet (step S203). Then, the buffer time processor 12 performs processing for storing, in the data cache 14, the packet with the current time information added (step S204).

It is unnecessary to add the time information in step S203 to all packets determined in step S201 to be destined for the MN. For example, the buffer time processor 12 may select a specific packet or any packet as a test packet and add the time information only to the test packet.

In FIG. 2B, the buffer time processor 12 receives information (trigger) indicating that the MN (requesting node) has succeeded in connecting to the AP, and checks the connection of the MN (step S210). For example, this trigger is a signal (signal for notifying the buffer time processor 12 that the MN has moved to a communicable area of the AP) transmitted to the buffer time processor 12 from the network interface 11, but it is not limited thereto.

When receiving the trigger, the buffer time processor 12 performs processing for acquiring, from the data cache 14, a buffered packet destined for the MN (step S211). Then, the buffer time processor 12 acquires the current time from the internal clock 13, and extracts information (stored time) added to the buffered packet (step S212).

Next, the buffer time processor 12 uses the difference between the current time and the time extracted from the packet to calculate the buffering time for which the packet was buffered in the data cache 14 (step S213). The difference between the current time and the time extracted from the packet may be set as-is as the buffering time. Alternatively, time (average time) required for normal packet transfer processing can be subtracted to set the delay time caused by the buffer as the buffering time. Here, the buffering node 10 calculates the buffering time (i.e. the time obtained by subtracting the time the packet was stored from the time the packet is transmitted). However, instead of this calculation, the time the packet is transmitted in step S214 to be described later and the time the packet was stored may be both added to the packet and transmitted to the MN. In this case, the MN can calculate the buffering time from the time the packet is transmitted and the time the packet was stored.

Upon completion of the calculation of the buffering time of the buffered packet to be sent to the MN, the buffer time processor 12 adds this calculated buffering time to the buffered packet as time information (step S214). Then, the buffer time processor 12 transfers the packet with the added time information to the MN via the network interface 11. As a result, the packet is sent to the MN (step S215).

A preferred method of allowing the AR to add time information to a packet destined for an MN 30 is to tunnel the packet to the MN 30 and insert the time information in an option of a tunnel header. This method using the tunnel enables the AP to add an additional header to the packet without modifying the packet. This is useful when the packet is protected by any encryption scheme, such as IP security (IPSec), for example.

As another method, the AP can send the packet to the MN 30 using a layer 2 (data link layer) communication protocol with the time information to add time information after the layer 2 frame. The addition of the time information after the layer 2 frame can prevent the addition of the time information from interrupting checking using a checksum calculation.

When the packet destined for the MN 30 is not encrypted, the AP can add the time information to a header option or a trailer (corresponding to a payload portion) of the header of the packet.

When encryption technology such as IP security (IPSec) is used to protect the packet from malicious attackers, the AP can search for part of the packet (a portion not protected by IPSec) to add an option including the time information.

For example, there is a case where the packet is protected only by the IPSec authentication header (AH) method. In this case, since the header part of the packet is protected, if any information is inserted into the header, it will become difficult for the MN to check the authentication of the packet. Therefore, the AP cannot insert the option for the time information into the header. In this situation, the AP can insert the option for the time information into the trailer of the packet.

The opposite is also true. When the MN 30 is using only IPSec ESP (Encapsulating Security Payload), since the data part of the packet is protected, the AP can add the option for the time information to the header of the packet.

FIG. 3 shows an example of a network configuration in the embodiment of the present invention. In the network configuration shown in FIG. 3, a mobile node (MN) 30 is a communication node capable of notifying a buffering node to start buffering packets destined for the MN 30.

The MN 30 connects to an AP (access point) to establish a connection to the Internet 33 through links 310a and 311b. The MN 30 can connect to the AP using IEEE802.1x technology, but is not limited thereto.

In this network configuration, it is assumed that AP 10a and AP 10b also function as routers. The MN 30 can connect to AP 10a and AP 10b as first hop routers respectively for access systems 31a and 31b.

For example, IEEE802.11 or Bluetooth (registered trademark) can be used as link layer technology used for a network configuration in each of the access system 31a and 31b, but is not limited thereto.

The AP 10a and the AP 10b are buffering nodes having the additional function of providing the MN 30 with a buffering service. This enables the MN 30 to request the AP 10a and the AP 10b to buffer packets destined for the MN 30. The packets to be buffered are, for example, packets transmitted from a home agent (HA) 34 for managing the MN 30, but they are not limited thereto.

In this network configuration, it is assumed that the MN 30 is moving from the access system 31a to the access system 31b. This movement causes a change of the AP, to which the MN 30 is connected, from the AP 10a to the AP 10b. When such handover processing is performed, fast mobile IP (FMIP) can be used.

Here, a case where FMIP is used is considered. Suppose first that the MN 30 is connected to the AP 10a, and the MN 30 uses a prefix managed by the AP 10a to configure a primary care-of address (CoA).

The AP 10a notifies (advertises) the MN 30 of information related to the AP 10b, such as the IP address of the AP 10b, and the prefix managed by the AP 10b, but it is not limited to such information. Methods by which the AP 10a notifies the MN 30 of the information shall include, but not be limited to, use of a router advertisement (RA), for example.

Here, the MN 30 uses prefix information of the AP 10b inserted in an RA to configure an NCoA (New Care-of address), and transmits a fast binding update (FBU) message to the AP 10a.

It is preferred that the FBU should include, but not be limited to, a PCoA (previous Care-of address) of the MN 30 and a buffer time record requesting option (Record Buffer Time option). The record buffer time option is to notify the AP 10a that the MN 30 has requested the AP 10b not only to buffer a packet to be transmitted to the MN 30, but also indicate the buffering time of the packet.

When receiving the FBU from the MN 30, the AP 10a generates a handover initiate (HI) message, and sends it to the AP 10b. It is preferred that the HI message should include, but not be limited to, a flag (U flag) instructing the AP 10b to buffer packets to be transmitted to the PCoA and the NCoA of the MN 30, and to the MN 30, in addition to the record buffer time option. If succeeding in processing the HI message, the AP 10b may return an acknowledgement message (HAck message) to the AP 10a.

The AP 10b returns an FBAck (Fast Binding Acknowledgement) message to the MN 30 to notify the MN 30 that the FBU has been performed successfully. At this point, the MN 30 can perform processing for notifying the HA 34 of the NCoA of the MN 30 even before disconnecting the connection to the AP 10a. It is preferred that the MN 30 transmit the BU including the NCoA to the HA 34 immediately before disconnecting the connection to the AP 10a.

When succeeding in registering (associating) the NCoA of the MN 30, the HA 34 starts sending packets destined for MN 30 to the AP 10b. When receiving packets destined for the MN 30, the AP 10b performs above-mentioned method of calculating time information for packets to be buffered. In other words, after the MN 30 succeeds in connecting to the AP 10b, the AP 10b transfers, to the MN 30, the buffered packets destined for the MN 30 together with time information.

At this time, the AP 10b can not only transfer the buffered packets to the MN 30 using the layer 2 communication protocol, but also add the time information after the layer 2 frame.

In another method, the MN 30 requests the AP 10a to buffer packets destined for the MN 30 while moving to a communication area of the AP 10b and trying to make a connection to the AP 10b. Then, when succeeding in connecting to the AP 10b, the MN 30 transmits the FBU message to the AP 10a via the AP 10b to notify the AP 10a to start the transfer of buffered packets to the NCoA of the MN 30. This enables the AP 10a to tunnel the buffered packets destined for the MN 30 and insert time information as an option of the tunnel header.

The HI message may also include an option indicating the time when the AP should start calculating time information related to the MN. For example, the MN 30 can request the AP to start calculating the time information when the AP detects that the MN 30 loses the layer 2 connection with the AP.

As another method, the MN 30 can request the AP to start calculating the time information when data destined for the MN 30 and exceeding five megabytes are cached. As still another method, the HA 34 functions as a buffering node related to the MN 30 so that the HA 34 can calculate the above-mentioned time information.

In the embodiment of the present invention, the MN 30 has two interfaces respectively connected to different access systems. One of the interfaces of the MN 30 is connected to a third-generation cellar (3G) network, and the other is connected to a wireless network (Wi-Max).

The MN 30 generates plural binding entries at a correspondent node (CN). In other words, the MN 30 binds, at the CN, the CoA connected to the 3G network and a home address (HoA) of the MN 30. Further, at the HA 34, the HoA of the MN 30 is associated with the CoA of the MN 30 in the Wi-Max network.

When the Wi-Max interface of the MN 30 reconnects to the Wi-Max network, the MN 30 requests the CN to send test packets using both entries at the CN. Here, the test packet is formatted to include the time of transmission from the CN, but not limited thereto.

Simultaneously, the MN 30 transmits the record buffering time message to the HA 34 to request the HA 34 to indicate the time of buffering a packet to the MN. When the test packet has arrived from the CN, the HA 34 buffers the packet and starts a timer to record how long the packet will remain buffered.

Then, when succeeding in reconnection through the Wi-Max interface of the MN 30, the MN 30 transmits the BU to the HA 34, indicating that the Wi-Max interface is active. Here, the HA 34 can tunnel the test packet to the MN 30 together with the time information.

The HA 34 may consist of plural home agents for managing the MN 30. Such a network is configured to include a case where respective HAs are used in cooperation with one another when the MN belongs to the plural HAs and has plural home addresses, and a global HA-HA system in which the plural HAs cooperate with one another to work as a geographically distributed home agent. In the global HA-HA system, the HAs corporate with one another to form a geographically distributed overlay network to provide end users with transparent route optimization.

In a scenario using the plural HAs, a buffering cache for the MN 30 is distributed among the plural HAs. If a data cache of an HA becomes full, the HA passes a packet to the next HA so that the packet will be cached at the next HA.

Further, if the cache of this HA also becomes full, this packet is passed to the next HA. Thus, a packet reach an HA whose cache is not full, or the packet is passed to the next HA until the packet is discarded because caches of all the HAs are full.

The first HA that starts the transfer of a packet to the next HA can add packet time information to the packet to be transferred. This HA can also notify all the HAs not to add the time information to this packet. A method of notifying all the HAs not to add time information is to cause the first HA to add a flag to the packet, but the method is not limited thereto. This flag aims to override the function of an intermediate HA(s) to add time information to the packet. In some case, this override function is effective.

As another method, instead of causing the MN 30 to transmit a request to the AP to start recording of time information, this processing may be started by the HA. In this case, the HA can transmit, to the MN 30, a special packet with an index attached to search for a node (buffering node) on a path, which provides a buffering service. Then, the HA can negotiate with the buffering node found during the search to perform buffering and calculate time information for a packet related to the MN.

When receiving the packet that was buffered at the AP together with the time information on the buffered packet, the MN 30 can use this time information to calculate latency between the AP and the HA 34 (time required to transfer the packet) more accurately. For example, the packet transmitted from the HA 34 includes information on the time the packet was transmitted. When calculating the latency between the AP and the HA 34, the MN 30 calculates a difference between the time the packet was transmitted from the HA 34 and the time at which the MN 30 received the packet. This difference in time is the time required to transfer the packet from the HA 34 to the MN 30, and based on the difference in time, the latency between the AP and the HA 34 is calculated more accurately.

Although this latency can be measured at a time when receiving of the packet buffered immediately after handoff of the MN is started, since the latency approximately matches the latency at a more stable communication after the time of completion of buffering, a determination (such as determination of a filter rule) can be made more rapidly based on the measured value than a case where the latency is measured after waiting until the transfer of the packet becomes stable.

Further, in order to more approximate the latency measurement to the latency measurement at the time of stable packet transfer, the time required to transfer the packet from the HA 34 to the MN 30 can be calculated by setting, as measurement start time, timing at which the AP 10a transfers the packet to the AP 10b, and as measurement end time, timing at which the AP 10b transmits the packet to the MN. In this case, the AP 10a and the AP 10b need to be synchronized in time with each other.

Further, the mobile node (MN 30) may set a filter rule for its own home agent (HA) so that the HA can test network conditions between the MN and the HA. For example, the MN 30 can set a special filter rule for requesting the HA to transmit test packets to the MN 30 via various paths.

A method of setting a filter rule for the HA is especially useful for a scenario like Monami6. In Monami6, the MN having plural interfaces needs to grasp various network conditions for each interface before determining a path associated with a flow transmitted from the correspondent node (CN).

Setting of this filter rule is performed at the HA by the MN, and this has the advantage of being capable of starting testing without the need for the MN to continue to transmit the request to the HA.

In the following, the term “tester node” represents a communication network node for transmitting plural test packets to a receiving node to start a test program in order to test network conditions for the receiving node.

Here, a case where a home agent (HA) is the tester node is described, but not limited thereto. The tester node can be implemented by any communication device having the ability to start a test function to be described below.

FIG. 4 shows a preferred configuration example of a tester node 40. The tester node 40 shown in FIG. 4 has one or plural network interfaces 41, a filter rule processor 42, a filter cache 43, and a test packet generating section 44.

The network interfaces 41 form a functional block containing all hardware and software necessary for the tester node 40 to communicate with another node through any communication medium.

In terms of terminology, known to those skilled in the art, the network interfaces 41 represent communication components, firmware, drivers, and a communication protocols of layer 1 (physical layer) and layer 2 (data link layer). Although only one network interface 41 is shown in FIG. 4, the tester node 40 can have one or plural network interfaces 41. The network interface 41 can also pass a packet to the filter rule processor 42 through a signal/data path 410.

The filter rule processor 42 has the function of performing processing for various filter rules defined by the MN. When receiving a packet from the network interface 41, the filter rule processor 42 transmits a signal to the filter cache 43 to search for a filter rule related to the packet.

As a result of referring to the filter rule stored in the filter cache 43, if it is found that the filter rule related to the packet specifies that various paths to the MN are to be tested, the filter rule processor 42 causes the test packet generator 44 to start the generation of test packets used for testing the various paths to the MN.

When the filter rule processor 42 receives a filter rule generated by the MN, the filter rule is stored in the filter cache 43. The filter rule processor 42 can store and search for the filter rule in and from the filter cache 43 through a signal/data path 420.

Further, the filter rule processor 42 can cause the test packet generator 44 to start the generation of test packets through a signal/data path 421. The filter rule processor 42 can give an instruction, through a signal/data path 422, about a method of sending a packet to the MN 30.

The test packet generator 44 has the function of generating various test packets to be transmitted to the MN to test network conditions for the various paths to the MN. Any packet can be used as a test packet, but it is preferred to use a copy of an original data packet to be transmitted to the MN. If the original packet has been transmitted via a specific path, use of the copy of the original packet makes it possible to test processing for actual packets in an access system between the HA and the MN.

The test packet generator 44 can pass the generated test packets to the filter rule processor 42 through a signal/data path 440 to start tests for the various paths to the MN.

Filter rules related to the tester node are stored in the filter cache 43. The filter rules include information related to the method of sending a packet destined for a node. The filter rule processor 42 acquires appropriate filter rule through a signal/data path 43 to perform processing.

In the present invention, a special filter rule is so introduced that the HA can transmit test packets via the various paths to the MN by this special filter rule. This filter rule is defined by the MN, and may be transmitted to the HA by a binding update (BU) message, for example.

The HA processes this BU message and stores, in the filter cache 43, a filter rule included in the BU message. This special filter rule may also be applied, for example, when a flow to the MN does not match any filter (i.e., when an appropriate filter rule is not found).

FIG. 5 shows an example of a format of the binding update message (BU message 50) used in the embodiment of the present invention The BU message 50 shown in FIG. 5 has an IPv6 header 51, a destination option header 52, a mobility header 53, a binding update header 54, a filter option 55, and a test option 56.

The IPv6 header 51 is 40 octets at the beginning of the packet, including a source address and a destination address (128 bits, respectively), a version (4-bit IP version), a traffic class (8 bits, packet priority), a flow label (20 bits, for QoS management), a payload length (16 bits), a next header (8 bits), and a hop limit (8 bits, time to live).

In a standard mode, the payload can be maximally 64 Kbytes, or when the IPv6 header 51 has a “jumbo payload” option, the payload becomes greater size. If an option exists, an added option header is specified in the next header field that follows the IPv6 header.

The destination option header 52 is used to insert additional information necessary to be processed by only a destination node of the packet. As a preferred example of this, the home address is inserted in the destination option header 52. This makes it possible to notify a recipient of the home address of the mobile node even if the mobile node is away from its home.

The mobility header 53 is an extension header used when the mobile node, the correspondent node, and the home agent perform all messaging related to creation and management of binding. The type (8 bits) of the mobility header, which is used to identify a specific mobility message as a target, is included in the mobility header 53. In the preferred embodiment of the present invention, the value of MH type is set to “5” indicating that the message is the binding update (BU) message.

Information necessary for the mobile node to notify another node of a new care-of address is included in the binding update header 54.

The filter option 55 is used to transmit a filter rule defined by a user of the MN 30. This filter rule enables the MN 30 to instruct a node, which is filtering a flow of the MN 30, about information related to the method of sending the flow to the MN 30. In the preferred embodiment of the present invention, the node that is filtering the flow of MN 30 is the HA 34.

In the embodiment of the present invention, a case where the filter rule includes filter identification information, the CoA of the MN 30, the source address of the CN, etc., but not limited thereto.

Further, in the present invention, a new option (which may also be called a test option 56) is introduced into the BU 30. The MN 30 uses the test option 56 to instruct the HA 34 about information related to a test the MN 30 wants the HA 34 to perform. The kinds of tests possible to specify in the test option 56 shall include, but not be limited to, several test methods such as periodic test, buffering test, and statistical test. The details of each test method will be described later in the embodiment.

When receiving the BU from the MN 30, the HA 34 performs BU processing to generate a binding entry for the MN 30 Thus, when the MN 30 is authenticated as a valid subscriber to the HA 34, the HA 34 associates the HoA of the MN 30 with the CoA indicated by the MN 30.

If filter rules defined by the MN 30 are included in the BU 30, the HA 34 stores these rules in the filter cache 43.

For example, the MN 30 has two CoAs. CoA 1 is associated with an interface through which the MN 30 is connected to the Wi-Max network, and CoA 2 is associated with another interface through which the MN 30 is connected to the 3G network.

When the source address of the packet received at the HA 34 does not match any packet source address existing in the filter rules defined by the MN 30, the MN 30 sets a filter rule (e.g., filter rule: FID1) for causing the HA 34 to transfer the packet to CoA 2.

Thus, when receiving a packet whose source address does not match any filter rule defined by the MN 30, the HA 34 triggers (initiates) FID1 to transfer the packet to CoA 2 of the MN 30.

Here, the HA 34 finds that the test option 56 is further included in the BU. The test option 56 is to notify the HA 34 to assist the MN 30 in testing conditions of networks (various networks to which the M 30 is connected).

For example, when the MN 30 sets the test option 56 and the FID1 is initiated, the MN 30 notifies the HA 34 to set a duplicate of the test packet heading toward another interface of the MN 30.

Then, when the HA 34 initiates FID1, the HA 34 refers to the test option related to FID1 to generate the duplicate of the test packet transmitted via CoA 1 of the MN. This enables the MN 30 to instruct the HA 34 about timing of starting a test mechanism.

FIG. 6 shows an example of processing in which the tester node in the embodiment of the present invention determines whether a specific packet is a trigger for the test mechanism.

In FIG. 6, when receiving a packet destined for MN 30 (step S600), the filter rule processor 42 performs check processing as to whether identification information of the packet (e.g., any information included in the packet such as a source address) matches that of a filter rule defined by the MN 30 (FID check) (step S601).

If it is found that the identification information matches that of any filter rule, the filter rule processor 42 performs processing for the filter rule and notifies the network interface 41 about the method of sending the packet to the MN 30.

On the other hand, if the filter rule processor 42 cannot specify any filter rule for this packet, the filter rule processor 42 causes the test packet generator 44 to start the generation of a test packet used for testing various paths to the MN 30 (step S602). The test packet may be any packet destined for the MN 30. For example, a packet as a copy of an original data packet to be transmitted to the MN 30, or a packet of the same size as the original data packet to be transmitted to the MN 30 is preferred. Further, a binding refresh request (BRR) message of the same size as the original data packet can also be used to urge the MN 30 to transmit the BU message that reflects new network conditions through test packet transmission or the filter rule update message. The test packet generator 44 transmits the test packet to the filter rule processor 42.

The filter rule processor 42 adds a timestamp to the original packet and the test packet (packet obtained by copying the original packet) according to the above-mentioned method of adding the time information, and instructs the network interface 41 about the method of transmitting packets to the MN 30 via the various paths, thus transmitting packets toward the MN 30 (step S603).

The filter rule processor 42 may also transmit the original packet and the duplicate packet in a distributed manner to the various paths heading for the MN 30, respectively, without adding the timestamp to the original packet and the duplicate packet. This allows the MN 30 to check network conditions for the various paths. Further, the tester node sends packets to the various paths heading for the MN 30 at the same timing to acquire a difference in transmission time between paths from the tester node to the MN 30, enabling comparison.

The MN 30 can also set the test option to request the HA 34 to transmit the test packets periodically through the various paths heading for the MN 30. This method has the advantage that the MN 30 can acquire more accurate network conditions for a certain period and perform normal update of the access path to the MN 30.

Thus, the flow path to the MN 30 can be updated periodically.

Further, the MN 30 can set the test option to notify the HA 34 to buffer packets to be sent to the MN 30 and execute the test program. This method allows the HA 34 to use, as the test packets, actual packets to be sent to the MN 30. The HA 34 transmits these test packets toward respective paths to the MN 30 almost at the same time. This method has the advantage of eliminating the need to generate the duplicate packet for testing because the HA 34 uses the test packet generator 44. This method also has the advantage of eliminating the need to add the timestamp to the packets because the packets are transmitted almost at the same time.

Further, the MN 30 can use the test option to instruct the HA 34 to send a packet via each path to the MN 30.

For example, the correspondent node (CN) transmits a stream of packets destined for the MN 30 via the HA 34. The HA 34 sends the first packet to the MN 30 via a first path to the MN 30. The HA 34 sends the second packet via a second path (different from the first path) to the MN 30. Packet sending processing is performed in the same manner until completion of testing all the paths. This method has the advantage of eliminating the need to generate the duplicate packet for testing because the HA 34 uses the test packet generator 44.

Further, the MN 30 can set the test option to notify the HA 34 that the MN 30 desires statistical results of all of the various paths. For example, after checking this test option, the HA 34 transmits packets of various sizes through the various paths to the MN 30 so that the MN 30 can collect pieces of statistical information on each path to the MN 30. This method allows the MN 30 to collect statistics on each path between the MN 30 and the HA 34.

In the above-mentioned method, the test packets are generated by the HA 34 and received by the MN 30. As a result, the MN 30 can determine access conditions for tested links to the HA 34 based on the information obtained from the test packets received. Further, the MN 30 can use the access conditions thus obtained to select a link appropriate for a specific flow to be sent to the MN 30. Then, the MN 30 sets a filter to the HA 34. This filter is to instruct the HA 34 to send the specific flow to the MN 30, for example, via the selected link between the MN 30 and the HA 34.

The MN 30 can also generate a test packet. In this case, the MN 30 can use a filtering binding message as the test packet and transmit the filtering binding message via the various paths to the HA 34. In this method, time information is included in the filtering binding message, so that the HA 34 can specify the best path available for the specific flow to the MN 30. After specifying the best available path, the HA 34 returns an acknowledgement message indicating whether binding is done successfully. This method has the advantage that the MN 30 can select which flow to test.

In aforementioned various examples, such a case that the MN 30 sets the filter rule and the test option in the BU one at a time is described, but the MN 30 can also set two or more filter rules and test options in the BU, respectively.

In the present invention, buffering and/or access condition testing are mostly requested by the MN 30. The operation performed by the function of the MN 30 to make such requests will be described below with reference to FIG. 7. FIG. 7 shows an example of processing performed by the MN in connection to various requests to be processed by the mobile node in the embodiment of the present invention.

When a trigger command is received at the MN 30, the function of requesting buffering and/or access condition testing (request function) is activated (step S700). The trigger command is generated, for example, by activating a policy set by user input or set in the MN 30, but not limited thereto.

The request function determines, based on the trigger received, whether the trigger is to request only buffering (buffer trigger) (step S701). If the trigger is the buffer trigger, the request function generates a buffer request message having the record buffer time option (step S702). For example, when the MN 30 is executing FMIP, a fast binding update (FBU) message can be used as the buffer request message. When the MN 30 is requesting buffering of packets from the HA 34, the binding update (BU) message can be used as the buffering request message.

However, if the trigger is not the buffer trigger the request function of the MN 30 checks whether the trigger is to request only access condition testing (test trigger) (step S703). If the trigger is the test trigger, the request function generates a test request message having the test option 56 (step S704).

The test option 56 indicates the type of access condition testing requested by the MN 30 (e.g., as to whether to request a statistical test on an access condition or a one-time test on the access condition.

In step S703, if the trigger is not the test trigger, the request function checks whether the trigger is to request both buffering and access condition testing (test and buffer trigger) (step S705). If the trigger is the test and buffer trigger, the request function performs processing for generating a request message including both the record buffer time option and the test option 56 (step S706).

For example, suppose that the MN 30 is communicating with the AP 10b in such a state that the MN 30 is connected to the AP 10a, and is about to move to a wireless coverage provided by the AP 10b. The MN 30 transmits, to the HA 34, the request message including both the record buffer time option and the test option 56 before disconnecting the connection to the AP 10a. For example, the binding update (BU) message can be used as the request message.

Further, the MN 30 instructs the HA 34 as an agent for the MN 30 to notify the AP 10b to record the buffering time of a test packet related to the MN 30. The HA 34 transmits the test packet having the record buffer time option, and notifies the AP 10b to record the buffering time of the test packet related to the MN 30.

Further, in step S705, if the request function cannot assesses the request by the trigger command, the request function returns, to the user, an error message indicating that the request function was not able to perform processing on trigger command (step S707). Further, the request message is generated in any of steps S702, S704, and S706, the request function transfers this request message toward an appropriate destination (step S708).

Next, the operation of the MN 30 when receiving a test packet will be described with reference to FIG. 8. FIG. 8 shows an example of processing performed when the mobile node in the embodiment receives a test packet.

The MN 30 activates a test packet processing function when receiving a test packet (step S800), acquires information embedded in the test packet, and calculates latency between the MN 30 and the HA 34 (step S801). For example, the HA 34 and the MN 30 synchronize their internal clocks with each other using NTP.

If the information embedded in the test packet includes a timestamp added by the HA 34 to indicate the time when the test packet was sent from the HA 34 (sending time), the MN 30 subtracts the sending time defined in a timestamp option from the receiving time of this packet to calculate the latency. For example, if the MN 30 receives the test packet with a timing of 1000 milliseconds and understands the timestamp option that this packet was sent with a timing of 800 milliseconds, the latency between the MN 30 and the HA 34 will be 200 milliseconds.

After calculating the latency, the MN 30 determines whether the record buffer time option is added to the test packet (step S802). If it is detected that the record buffer time option is added to the test packet, the test packet processing function performs processing for acquiring time information included in the record buffer time option (step S803). This time information indicates the time for which the test packet was stored in the buffer of the AP 10 before being transmitted to the MN 30 (buffering time information).

After acquiring the time information from the record buffer time option, the test packet processing function calculates actual latency between the MN 30 and the HA 34 (step S804). The test packet processing function subtracts the time information acquired in step S803 from the latency calculated in step S801 to calculate the actual latency. For example, suppose that the time information indicates that the test packet for the MN 30 was buffered for 50 milliseconds in the buffer at the AP10. In this case, when the MN 30 calculates actual latency, the MN 30 subtracts 50 milliseconds from the latency of 200 milliseconds calculated before, and as a result, a value of 150 milliseconds is obtained as the actual latency. Thus, the actual latency between the MN 30 and the HA34 is 150 milliseconds.

Using information on this calculation result, the test packet processing function notifies the user of the time required to transmit the packet from the HA 34 to the MN 30 (step S805). Further, if it is determined in step S802 that the record buffer time option is not added to the test packet, the test packet processing function notifies, to the user, the latency (200 milliseconds as mentioned above) calculated in step S802 as the time required to transmit the packet from the HA 34 to the MN 30 without considering the buffering time.

Here, the mobile node performs processing on the trigger command, but such a function may be implemented by another node (e.g., AR or HA) that supports the features according to the present invention. Further, the function of the mobile node to perform test packet processing may also be implemented by another node that supports the features according to the present invention.

FIG. 9 shows an example of a configuration of the mobile node in the embodiment of the present invention. The mobile node 90 shown in FIG. 9 has one or plural network interfaces 91, a request function implementing section 92, and a test packet processing function implementing section 93. Packets received by the network interfaces 91 are passed to the request function implementing section 92 through a signal/data path 910, or the test packet processing function implementing section 93 through a signal/data path 930, depending on the type of packet. When the request function implementing section 92 transmits packets to an external network node, the packets are passed to the network interfaces 91 through a signal/data path 920. When the test packet processing function implementing section 93 transmits packets to the external network node, the packets are passed to the network interfaces 91 through a signal/data path 940.

The network interfaces 91 form a functional block containing all hardware and software necessary for the mobile node 90 to communicate with another node through any communication medium. Like the network interfaces 11, 41 shown in FIG. 1 or FIG. 4, the network interfaces 91 represent communication components, firmware, drivers, and a communication protocols of layer 1 (physical layer) and layer 2 (data link layer). Since the mobile node 90 carries out communication while moving, the network interfaces 91 have wireless capabilities.

The request function implementing section 92 has the function of requesting a predetermined network node to perform buffering and record buffering time, or sending test packets, and it can provide the operation shown in FIG. 7 described above.

Specifically, for example, the request function implementing section 92 has the function of requesting buffering of packets destined for the mobile node 90, the function of requesting recording of and report on the buffering time, the function of requesting transmission of test packets to the mobile terminal, etc.

The test packet processing function implementing section 93 has the function of performing processing for the test packets when receiving the test packets to acquire information (an access condition indicating the degree of stability of an access link, etc.) related to paths along which the test packets have been transmitted, and it can provide the operation shown in FIG. 8 mentioned above.

The test packet processing function implementing section 93 has the function of acquiring buffering time for which a predetermined packet (test packet) was buffered at the buffering node 10, the function of acquiring latency between the tester node 40 from which the test packet was transmitted and the mobile node 90 (latency including the time of being buffered at the buffering node 10), the function of subtracting the buffering time from the latency of the test packet to calculate latency when the packet is transmitted without being buffered at the buffering node 10, the function of synchronizing its internal clock with an internal clock of another network node (especially the tester node), etc.

In this specification, while the present invention has been illustrated and described by considering it to be the most practical and preferred embodiment, it will be apparent to those skilled in the art that various modifications may be made in terms of the design related to the above-mentioned components of each node and the details of the parameters without departing from the scope of the invention.

For example, the present invention is applicable to a mobile node, a mobile router, a mobile IP home agent, a home agent for network mobility, a buffering node including a virtual private network gateway, an IPv6-IPv4 conversion gateway, etc.

The present invention is also applicable to a localized mobility environment like NetLMM (Network-based Localized Mobility Management), for example. In the case of application to NetLMM, when the MN finds itself moving between access routers (ARs) arranged in the localized mobile environment, the MN requests an AR to buffer a packet belonging to the MN so that the AR can add time information (information on buffering time) to the packet thus buffered.

The AP can have components as shown in FIG. 6 to function as a tester node. In this case, the MN can request the AP to buffer packets related to the MN and the AP can set a rule defining a method of buffering for the MN. For example, the MN can transmit a filter rule option to the AP to set, to the AP, a rule indicative of buffering any type of traffic/packet/protocol.

Note that each of the functional blocks used in describing the aforementioned embodiment of the present invention is implemented as an LSI (Large Scale Integration) typified by an integrated circuit. These may be made up of one chip individually, or they may be made up of one chip to include some or all of them. Here, although the LSI is assumed, it may be called an IC (Integrated Circuit), a system LSI, a super LSI, or an ultra LSI depending on the degree of integration.

Further, the technique for creation of an integrated circuit is not limited to LSI, and it may be implemented by a custum IC or a general-purpose processor An FPGA (Field Programmable Gate Array) capable of programming after LSI manufacturing or a reconfigurable processor capable of reconfiguring connections or settings of circuit cells within the LSI may also be employed.

In addition, if integrated circuit technology capable of replacing LSI emerges with development of semiconductor technology or another technology derived therefrom, the technology may of course be used to integrate the functional blocks. For example, applications of biotechnology may be possible.

### INDUSTRIAL APPLICABILITY

The network node and the mobile terminal of the present invention can calculate a transmission delay in packet transmission between two nodes more accurately and check packet transmission conditions (network conditions), and are applicable to the field of communication technology for packet-switched data communication network systems In particular, they are applicable to a technique for determining a packet transmission delay due to buffering and other network conditions in a packet-switched data communication network system.

1. A network node connectable to a network, comprising:
packet receiving means for receiving a packet from the network;
packet buffer means for buffering the packet;
start of transfer determining means for determining start of transfer of the packet buffered in the packet buffer means;
packet transmitting means for transmitting, to a specific address, the packet buffered in the packet buffer means and for which the start of transfer is determined;
buffering time calculating means for calculating buffering time for which the packet was buffered in the packet buffer means; and
buffering time information transmitting means for transmitting, as buffering time information, the buffering time calculated by the buffering time calculating means to a forwarding destination of the packet to be transmitted by the packet transmitting means.

2. The network node according to claim 1, further comprising:
clock means having a clock function; and
buffer time processing section for storing, as buffer time information, time of a moment obtained from the clock means in association with the packet destined for the specific address, and causing the packet buffer means to buffer the packet destined for the specific address,
wherein when the start of transfer of the packet is determined by the start of transfer determining means, the buffering time calculating means calculates, based on current time obtained from the clock means and the buffer time information, buffering time information indicative of the buffering time for which the packet was buffered.

3. The network node according to claim 1, further comprising:
buffer request receiving means for receiving a buffer request for the packet destined for a mobile terminal when the forwarding destination of the packet is the mobile terminal, the packet being transmitted within the network while the mobile terminal is performing handover processing; and
buffer control means for buffering, in the packet buffer means, the packet destined for the mobile terminal while the mobile terminal is performing the handover processing,
wherein when detecting completion of the handover of the mobile terminal, the start of transfer determining means determines the start of transfer of the packet to the mobile terminal.

4. The network node according to claim 1, wherein when a request for the buffering time is received from a terminal as the forwarding destination of the packet, the buffering time related to the packet destined to the terminal that made the request is provided to the terminal.

5. The network node according to claim 1, wherein the buffering time information transmitting means transmits the buffering time information in such a manner to add the buffering time information to an end of a layer 2 frame of the packet or a tunnel header added to the packet.

6. A network node connectable to a network, comprising:
packet transfer means for transferring a packet transmitted in the network;
filter rule storing means for storing a filter rule related to a specific terminal; and
test starting means for performing processing to check a network condition up to the specific terminal associated with the filter rule that matches a condition when the packet transfer means receives the packet that matches the condition of the filter rule stored in the filter rule storing means.

7. The network node according to claim 6, further comprising:
duplicate packet creating means for duplicating the packet received by the packet transfer means to create a duplicate packet when the packet transfer means transfers the packet to the specific terminal; and
duplicate packet transmitting means for transmitting the duplicate packet to the specific terminal via a path different from a path through which the packet transferred by the packet transfer means passes.

8. The network node according to claim 6, further comprising:
clock means having a clock function; and
timestamp means for adding, to the packet and the duplicate packet, current time obtained from the clock means when being sent to the network.

9. The network node according to claim 6, wherein the test means transmits a test packet periodically to check a network condition up to the specific terminal.

10. The network node according to claim 6, wherein the test means transmits test packets of plural sizes to plural paths to the specific terminal, respectively.

11. The network node according to claim 6, further comprising
packet buffer means for buffering the packet transferred by the packet transfer means,
wherein the test means performs processing to check a network condition up to the specific terminal by transfer of the packet buffered in the packet buffer means.

12. A mobile terminal communicable with a network while moving, comprising:
packet sending/receiving means for connecting to the network to send and receive a packet;
buffering request means for requesting the network to buffer the packet destined for the mobile terminal in the network;
buffering time record requesting means for requesting the network to record buffering time for which the packet was buffered due to buffering requested by the buffering request means; and
buffering time receiving means for receiving the buffering time of the packet from the network in conjunction with reception of the packet buffered in the network.

13. The mobile terminal according to claim 12, further comprising:
packet sending time acquiring means for acquiring packet sending time when the packet was sent, from an arbitrary packet transfer device that transferred the packet buffered in the network;
packet receiving time acquiring means for acquiring packet receiving time when the packet buffered in the network was received by the packet sending/receiving means; and
effective latency calculating means for calculating a value as effective latency required for packet transmission from the arbitrary packet transfer device to the mobile terminal, the value obtained as a result of subtraction of the packet sending time from the packet receiving time and further subtraction of the buffering time of the packet.

14. The mobile terminal according to claim 13 further comprising synchronization control means for synchronizing a clock referred to by the arbitrary packet transfer device to acquire the packet sending time with a clock referred to by the mobile terminal to acquire the packet receiving time.

15. The mobile terminal according to claim 13, further comprising:
plural interfaces connectable to the network; and
access condition acquiring means for acquiring an access condition to each link between each of the plural interfaces and the arbitrary packet transfer device based on the effective latency of each of the plural interfaces calculated by the effective latency calculating means.
